(19) United States
(12) Patent Application Publication
(10) Pub. No.: US 2016/0203831 A1
(43) Pub. Date: Jul. 14, 2016

(54) MULTIPLE LIVE VOICE DISCUSSIONS STATUS

(71) Applicant: Kola Voice Technologies (Israel) Ltd., Tel-Aviv (IL)

(72) Inventors: Tal ELYASHIV, Ramat-HaSharon (IL); Yoseph TAGURI, Tel-Aviv (IL); Shmuel UR, Shorashim (IL)

(21) Appl. No.: 14/596,403

(22) Filed: Jan. 14, 2015

(51) Int. Cl. G10L 25/63; G06F 3/16

(52) U.S. Cl. CPC G10L 25/63; G06F 3/167

(57) ABSTRACT

A system for updating a user interface. The system comprises at least one monitoring module adapted to monitor a plurality of multi-participant voice discussions held in a plurality of voice chat rooms and a processing unit adapted to identify a plurality of current voice discussion features in each of said plurality of multi-participant voice discussions, update a user interface to reflect at least some of said plurality of current voice discussion features of each of at least some of said plurality of multi-participant voice discussions, and instruct the presentation of said user interface by a client terminal of a user.

### BACKGROUND

The present invention, in some embodiments thereof, relates to multi participant voice communication and, more specifically, but not exclusively, to management of multi participant voice chat rooms and a presentation of a user interface for participating in a multi participant voice chat room.

Historically, multi-participant events such as multi-party conferences have been hosted using Public Switched Telephone Networks (PSTNs) and/or commercial wireless networks. Although such networks allow multiple participants to speak at once, they are unsatisfactory because they provide no means for visually identifying each participant in the event. More recently, teleconferencing systems that rely on Internet Protocol (IP) based networks have been introduced. Such systems, which enable two or more persons to speak to each other using the Internet infrastructure. In IP based networks digitized speech is routed to participants across a network using the IP and “voice over IP” (VoIP) technologies. Accordingly, each participant to the multi-participant event has a client computer. When a participant speaks, the speech is digitized and broken down into packets that may be transferred to other participants using a protocol such as IP, transmission control protocol (TCP), or user datagram protocol (UDP). See, for example, Peterson & Davie, Computer Networks, 1996, Morgan Kaufmann Publishers, Inc., San Francisco, Calif.

### SUMMARY

According to some embodiments of the present invention there is provided a system for updating a user interface. The system comprises at least one monitoring module adapted to monitor a plurality of multi-participant voice discussions held in a plurality of voice chat rooms and a processing unit adapted to identify a plurality of current voice discussion features in each of the plurality of multi-participant voice discussions, update a user interface to reflect at least some of the plurality of current voice discussion features of each of at least some of the plurality of multi-participant voice discussions, and instruct the presentation of the user interface by a client terminal of a user.

Optionally, the presentation simultaneously renders the at least some of the plurality of current voice discussion features of each of the at least some multi-participant voice discussions.

Optionally, the user interface is adapted to receive a user selection of one of the plurality of voice chat rooms and to add the user to the selected voice chat room.

Optionally, the system further comprises a preference module to allow the user to define at least some of the plurality of current voice discussion features.

Optionally, the at least one monitoring module is adapted to extract, from each one of the plurality of multi-participant voice discussions, at least one audio stream documenting voice of a plurality of participants; wherein the processing unit is adapted to identify at least some of the plurality of current voice discussion features by voice analysis of the at least one audio stream.

More optionally, the voice analysis is a sentiment analysis and the plurality of current voice discussion features are selected from a group consisting of: an emotion expressed by one of the plurality of participants, a prevailing emotion expressed by at least some of the plurality of participants, an emotion trend expressed by at least some of the plurality of participants.

More optionally, the voice analysis is a speech analysis and the plurality of current voice discussion features are selected from a group consisting of: a word the by one of the plurality of participants, a term the by one of the plurality of participants, a word repeated by at least some of the plurality of participants, a term repeated by at least some of the plurality of participants.

More optionally, the voice analysis outputs a stress level as one of the plurality of current voice discussion features in at least some of the plurality of multi-participant voice discussions.

More optionally, the voice analysis outputs an activity level reflecting active participation of participants as one of the plurality of current voice discussion features in at least some of the plurality of multi-participant voice discussions.

Optionally, the at least one monitoring module is adapted to monitor data acquired from a voice chat unit managing the plurality of voice chat rooms, wherein the processing unit is adapted to identify at least some of the plurality of current voice discussion features by data analysis of the data.

Optionally, the at least one monitoring module is adapted to monitor a number of participants which actively participate in each one the plurality of voice chat rooms by at least one of playing respective the discussions and talking, wherein the number is one of the plurality of current voice discussion features.

Optionally, the at least one monitoring module is adapted to monitor an identity of participants which actively participate in each one the plurality of voice chat rooms by at least one of playing respective the discussions and talking, wherein the identity is one of the plurality of current voice discussion features.

Optionally, the user interface comprises a plurality of graphic elements, each comprises a plurality of indicators each one of the plurality of indicators represents one of the plurality of current voice discussion features.

More optionally, the plurality of graphic elements which are arranged in a grid.

More optionally, the plurality of indicators comprises a member of a group consisting of an icon of a participant, an icon of a notification, and a counter.

Optionally, the processing unit adapted to identify the plurality of current voice discussion features by an analysis of a recent period of the plurality of multi-participant voice discussions; wherein the recent period is shorter than 5 minutes.

Optionally, a client module executed at the client terminal is instructed to display the presentation of the user interface by receiving message transmitted over a computer network.

According to some embodiments of the present invention there is provided a method for updating a user interface. The method comprises monitoring a plurality of multi-participant voice discussions held in a plurality of voice chat rooms, identifying a plurality of current voice discussion features in each of the plurality of multi-participant voice discussions, updating a user interface to reflect at least some of the plurality of current voice discussion features of each of at least some of the plurality of multi-participant voice discussions, and instructing the presentation of the user interface by a client terminal of a user.

Optionally, the method further comprises receiving instructions to monitor the plurality of current voice discussion features from a user via another user interface executed at the client terminal.

According to some embodiments of the present invention there is provided a method for updating a user interface. The method comprises receiving a plurality of current voice discussion features in each of a plurality of multi-participant voice discussions held in a plurality of voice chat rooms, updating a user interface to reflect at least some of the plurality of current voice discussion features of each of at least some of the plurality of multi-participant voice discussions, and instructing the presentation of the user interface by a client terminal of a user.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a system for updating a user interface to reflect current voice discussion feature(s) of each of a plurality of multi-participant voice discussions held in a plurality of voice chat rooms, according to some embodiments of the present invention;

FIG. 2 is a flowchart of a method of updating a user interface to reflect current voice discussion feature(s) of each of a plurality of multi-participant voice discussions held in a plurality of voice chat rooms, according to some embodiments of the present invention;

FIG. 3 is an exemplary presentation of a panel of graphical elements that is optionally updated as described with reference to FIG. 2, according to some embodiments of the present invention; and

FIG. 4 depicts such an exemplary graphical element that is used in the panel of graphical elements of FIG. 3, according to some embodiments of the present invention.

### DETAILED DESCRIPTION

The present invention, in some embodiments thereof, relates to multi participant voice communication and, more specifically, but not exclusively, to management of multi participant voice chat rooms and a presentation of a user interface for participating in a multi participant voice chat room.

According to some embodiments of present invention, there are provided systems and methods for updating a user interface to reflect one or more voice discussion features which are extracted from an analysis of a plurality of multi-participant voice discussions held in a plurality of voice chat rooms. The user interface, for example a graphical user interface, presents a current state in each one of the voice chat rooms by presenting indicators of one or more voice discussion features. This allows a user to determine to which of the discussions to join and when.

For example, voice discussion features indicative of who is currently actively participating?, what is the level of participation?, what are the common words or terms used frequently in the discussion? How many are participating? Are friends or specific watched people participating? Is the discussion heated? And/or the like may be identified and presented by visual indicators to the user.

In another example, audio streams are extracted from a discussion and analyzed to determine sentiment(s), allowing the identification of the discussion based on stress levels, lies, and/or presence or absence of specific emotions.

According to some embodiments, the systems and methods allows a user to set custom voice discussion features for monitoring. The custom voice discussion features are monitored by the sensing modules to allow generating personalized notification to the user, for example by visual indicators of the user interface. In such a manner, a user can define word(s), theme(s) emotions, and/or discussion trends and to receive a visual notification or an alert when such a custom voice discussion feature is detected in one or more of the monitored voice chat rooms.

An exemplary system is implemented by one or more servers which include one or more monitoring modules to monitor a plurality of multi-participant voice discussions held in a plurality of voice chat rooms and a processing unit that identifies, based on an analysis, a plurality of current voice discussion features in each of the plurality of multi-participant voice discussions. This allows updating a user interface to reflect some or all of the current voice discussion features of each of some or all of the multi-participant voice discussions and instructing the presentation of the user interface by a client terminal of a user. The client terminal may be any network connected device, such as a Smartphone or a laptop and the user interface may be presented by a browser and/or an application executed on the client terminal.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

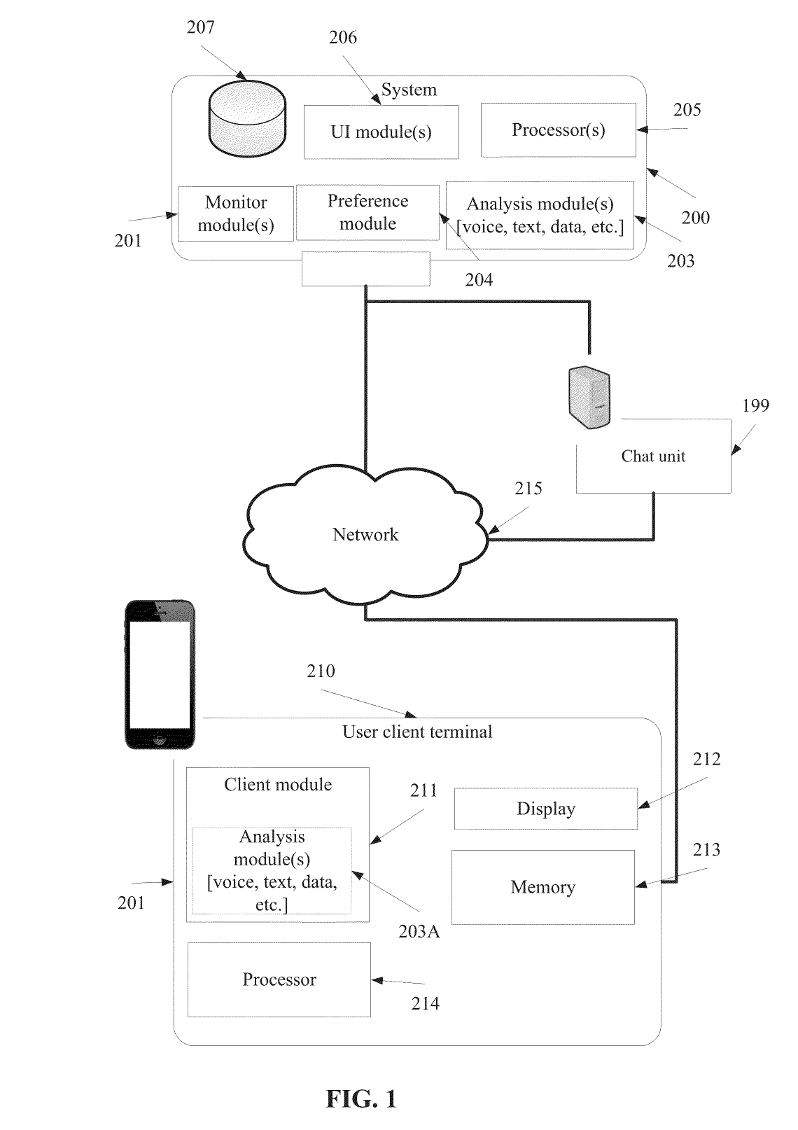

Reference is now made to FIG. 1, which is a schematic illustration of a system 200 for updating a user interface to reflect current voice discussion feature(s) of each of a plurality of multi-participant voice discussions held in a plurality of voice chat rooms, according to some embodiments of the present invention.

The system 200 is optionally a processing unit that includes one or more processors 205, for example central processing units (CPUs), for example one or more servers and/or virtual machines. The system 200 is optionally connected, either directly or via a network 215, or integrated with a chat unit 199, such as a voice chat unit, implemented by one or more servers or any other network nodes which manage voice chat rooms, optionally synchronous. As used herein, a voice chat room is a virtual area, such as a webpage, a widget, or a website on the Internet or other computer network where users can at least audibly communicate, synchronously as one time participants or asynchronously as registered participants which participate actively (e.g. by hearing or talking or uploading content) from time to time. A voice chat room may or may not be associated with communication rules limiting communication to a particular topic. The term chat room, or chatroom, is primarily used herein to describe any form of synchronous or asynchronous conferencing. The term can thus mean any technology ranging from real-time online chat and online interaction with strangers instant messaging and online forums to fully immersive graphical social environments.

For participants, an exemplary use of a voice chat room is to share information via audio with a group of other users. Generally speaking, for a user, the ability to converse with multiple people, some may not be socially connected to the user, in the same conversation differentiates chat rooms from instant messaging programs, which are more typically designed for one-to-one communication. The users in a particular chat room may be generally connected via a shared interest, location or topic. Participants in a voice chat room may use the chat room platform for file sharing, screen sharing, texting, content editing, video conferencing using webcams, gaming and/or the like.

According to some embodiments of the present inventions, subscribers to of the system 200, for instance subscribers of the chat unit 199, are registered to selected voice chat rooms. The discussions in each of the voice chat rooms may continuous such that participants which are registered to the voice chat rooms can asynchronously hear (or not hear) to currently active participants, react and participate at their convenience, for instance when the current voice discussion feature(s) which are presented by indicators of the UI reflect a matter of importance for them. In such embodiments, each user can be registered to many voice chat rooms.

Optionally, voice chat rooms are established by subscribers. Optionally, during the establishment, friends are invited and/or authorized to join the voice chat room. Subjects of voice chat rooms can be a Class of a certain academic institute of school (Class 96 of Scottsdale community college), a hobby subject (e.g. Foodies, restaurants, running, celebrities, music genre, movies, etc.), a professional subject (e.g. electric engineering, software, patent examination, medicine, etc.), a location (e.g. Scottsdale community), an activity group (e.g. Chelsea bikers), and/or any subject of interest to a certain group of people.

The system 200 includes one or more monitoring modules 201 adapted to monitor, in real time, plurality of multi-participant voice discussions held in the plurality of voice chat rooms, optionally synchronous.

The system 200 includes one or more analysis modules 203, such as a voice analysis module 203, a profile analysis module 203, an adjacent data analysis module, and/or the like. Optionally, user profiles are locally stored in a repository such as 207.

The system 200 includes a user interface (UI) management module 206 for updating the UI, for example a graphical user interface (GUI) that is presented on the display of a plurality of client terminals, such as laptops, Smartphones, tablets and/or the like. The updating allows a user to select in which of the currently held discussions to participate and to receive a current state of discussion in each one of the plurality of voice chat rooms, for instance as one or more current voice discussion feature of the discussion held in each of the voice chat rooms. The current state may be presented by one or more icon, values, scores and/or the like.

The modules are optionally implemented as software objects executed using the processors 205.

The modules are optionally implemented as software objects integrated or communicate with the chat unit 199 to query for some of the current voice discussion features described hereinbelow.

Optionally, the updated UIs, for example GUI are presented by chat client modules 211 which are installed or executed on a client terminal 210 having a display 212, memory 213 and a processor 214, such as a cellular phone, Smartphone, tablet, laptop, desktop, and/or the like. The chat client modules 211 may be an application, such as a chat application and/or a browser based component, such as a client side browser rendered component, such as an asynchronous JavaScript and XML (AJAX) component. The chat client modules 211 may include the analysis module(s) as depicted in 203A to perform analysis which is described herein locally. The UI client module may be a tread or a software component managed at the system 200. The display of the UI allows a user to view current status of discussions in different voice chat rooms with a single glimpse. The presented current statuses are optionally of voice chat rooms of interest to the user.

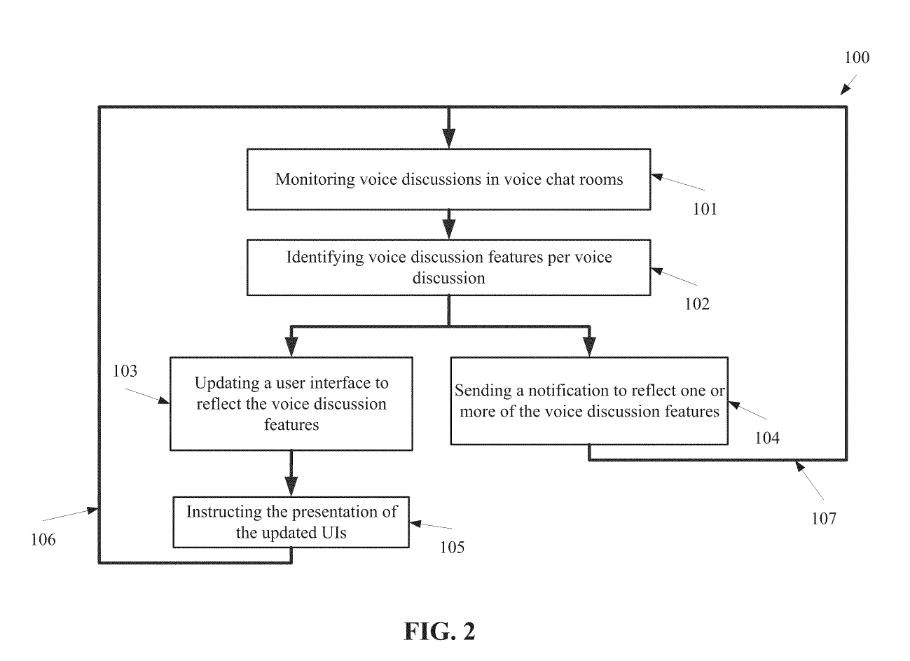

Reference is now also made to FIG. 2 which is a flowchart of a method of updating a user interface with a current voice discussion feature of a plurality of multi-participant voice discussions held in a plurality of voice chat rooms, according to some embodiments of the present invention.

First, as shown at 101, as described above, for example using the monitoring modules 202, multi-participant voice discussions held in a plurality of voice chat rooms are monitored. The monitoring is optionally performed continuously, iteratively, and/or upon event detection to assure real time current voice discussion feature identification.

Optionally, an audio data stream is identified per participant, either from the chat unit 199 or by separating audio data streams from a recording of voice in the voice chat room. The audio data stream 100 may be identified per participant of the multi-participant voice discussion, optionally based on adjunct data about the user, for example user metadata extracted from his or her profile.

Now, as shown at 102, the multi-participant voice discussions are analyzed to identify, per currently held multi-participant voice discussion, voice discussion features. The analysis is optionally of current audio streams of participants in the multi-participant voice discussions. The analysis is optionally of user profiles of current participants and/or data extracted from the chat unit 199 about the state of the voice chat room and/or data shared therein. The analysis is optionally performed continuously, iteratively, and/or upon event detection to assure real time current voice discussion feature identification.

Optionally, the analysis modules identify who is currently participating in the voice chat room and optionally the level of participation thereof. Actual participation may be evaluated by inspecting voice chat room by the voice analysis module 203 and/or by analyzing logs or data outputs of the chat unit 199. Level of participation may be determined by the voice analysis module 203 according to voice or audio stream analysis. Possibly the chat unit 199 is queried for this information.

Additionally or alternatively, one or more of the analysis modules identify one or more current voice discussion features such a current voice level, a voice emotion trend, a voice note or in multi-participant voice discussion. Voice emotion trend may be extracted by the voice analysis module 203. For example, sentiment analysis algorithms may be applied on one or more of the audio streams. For example, each audio stream is analyzed to extract words. The words are analyzed and the occurrence of keywords or types of words is flagged. This allows applying text-based sentiment intelligence algorithms to classify an emotion such as anger, fear, happiness, love and/or the like as a current voice discussion feature. Emotion data detected from an analysis of the audio streams may be combined to determine a discussion profile. Additionally or alternatively, lies may also be detected to determine honesty level in the discussion. The monitoring module(s) 201 may be programmed to learn the speech patterns of participants so their respective contributions can automatically be flagged. The voice analysis module 203 may further be programmed for recognizing stress levels in a participant's voice and to classify a stress level in a discussion as a current voice discussion feature accordingly.

Additionally or alternatively, a voice discussion feature is “who the currently speaking participant is”? or which of the participants lately participated in the discussion?, for example talked, texted or uploaded content during the last few seconds or minutes.

Additionally or alternatively, one or more of the analysis modules identify a current discussion subject per voice discussion. For example, the voice analysis module 203 may be programmed to identify specific word patterns and generate specific tags associated with the detected term(s). The voice analysis module 203 may classify the subject of the discussion as a current voice discussion feature accordingly.

Additionally or alternatively, one or more of the analysis modules identify a current voice discussion feature based on an analysis of user profiles of current participants. For example, the current voice discussion feature may be an average age, gender, hobbies, geographical origin, group association etc. which are extracted from user profiles of participants.

Additionally or alternatively, one or more of the analysis modules identify a current voice discussion feature based on content shared in the voice chat room. For instance a log of a chat room may be analyzed by a data analysis module.

Additionally or alternatively, the one or more of the analysis modules analyze the data monitored by the monitoring module(s) 201 to detect presence or absence of custom voice discussion features which are defined by one or more users of the system. In such embodiments, the system 200 includes a preference module 204 to allow user(s) to define custom voice discussion features. A detection of a custom voice discussion features may be a detection or a failure to detect a word, a term, a sentence, a verbal behavior, a pattern, a change, or a trend in one or more multi-participant voice discussions which are held in one or more voice chat rooms. For example, a custom voice discussion feature may be a word or a term that is being said by a participant in a multi-participant voice discussion, a prevalence of any voice discussion feature such current voice level, a voice emotion trend, a voice note or in multi-participant voice discussion and/or the like. In another example, a custom voice discussion feature may be an active or passive participation or an active or passive non participation of certain subscribers of the system 200 or the chat unit 199.

Now, as shown at 103, the UI that presents a user with an option to join any of the voice chat rooms is now updated to reflect current voice discussion feature(s) of each one of the respective voice discussions held in the voice chat rooms. The updating is performed by the UI module 206. As indicated above, different users may set different custom voice discussion features. The UI module 206 may update different GUIs which are associated with different users according to different custom voice discussion features and/or user preferences. The UI module 206 may update different GUIs which are associated with different users according to the voice chat rooms to which the users are registered to. In such embodiment, a UI present the current voice discussion feature(s) of current discussions in each one of the voice chat rooms to which the respective user is registered to.

Additionally or alternatively to the updating of the presentation of the UI, as shown at 104, notifications may be sent to users to notify about one or more of the current voice discussion feature(s). For example, a user may be registered to receive notifications when certain voice discussion feature(s) are identified in one or more voice chat rooms. In response to detection, for example as described above, notifications are presented or sent, for instance via emails, alerts, SMS messages, IM messages and/or the like.

Optionally, participants can notify other users who are not currently active that now is an interesting time to participate. For example, a participant in a chat-room discussion instructs the sending of an alert to friends from a geographical area about a discussed subject. Alert target group may be selected by according to textual group feature definitions, for instance “invite people from NY area” or “invite bikers”. An NLP engine may be used to convert the input to a group definition.

As shown at 105, the presentation of the UIs, for example by the client modules 211, is instructed.

As shown at 106, 107, the process may continuously or iteratively repeat to update the UI to reflect a real time status of each one of the discussions in each one of the chat rooms and/or to send notification as described above.

As the above current voice discussion feature(s) which are given to chat rooms may be based on an analysis of audio streams and/or activity monitored at a predefined proceeding period, for example during the last, few seconds or minutes and/or a limited period, for instance last 5, 10, 15, 30, and 60 minutes or any shorter or intermediate period. In such embodiments, the above current voice discussion feature(s) reflect a current state or trend of discussion in the voice chat room.

Each UI contains current voice discussion feature indicators which are indicative of the current voice discussion feature(s) of each one of the discussion held in the voice chat rooms of the respective user. An indicator of a certain current voice discussion feature visually reflects its essence. For example, the indicator(s) of a currently or lately speaking participate(s) are icon(s) or thumbnail(s) thereof. An indicator of how many participants are currently active in the voice chat room may also be presented, for example a size changing icon or a number. An indicator of what percentage of the people is currently active may also be presented. An indicator that the group is currently active or inactive may be presented, for example based on the evaluation of the level of participation above. When the group is not active an indicator of a last activity time may be presented. When the group is active an indicator of a last inactivity time may be presented.

As described above, some custom voice discussion features may be defined. Indicator may be indicative of these custom voice discussion features. For instance, when a participant sets word (such as the word Humus), an indicator indicative of the usage of that word in the currently held discussion is presented.

Optionally, the generated UI includes, per voice chat room selected for the user or by the user, a graphic element with indicators to reflect the current voice discussion features. Some or all of the graphic elements are presented simultaneously to allow the user to select a voice chat to listen to and/or to participate actively in.

Optionally, participants may invite friends to join a voice chat. In such embodiments, the invited user may be presented with an indicator on the generated UI.

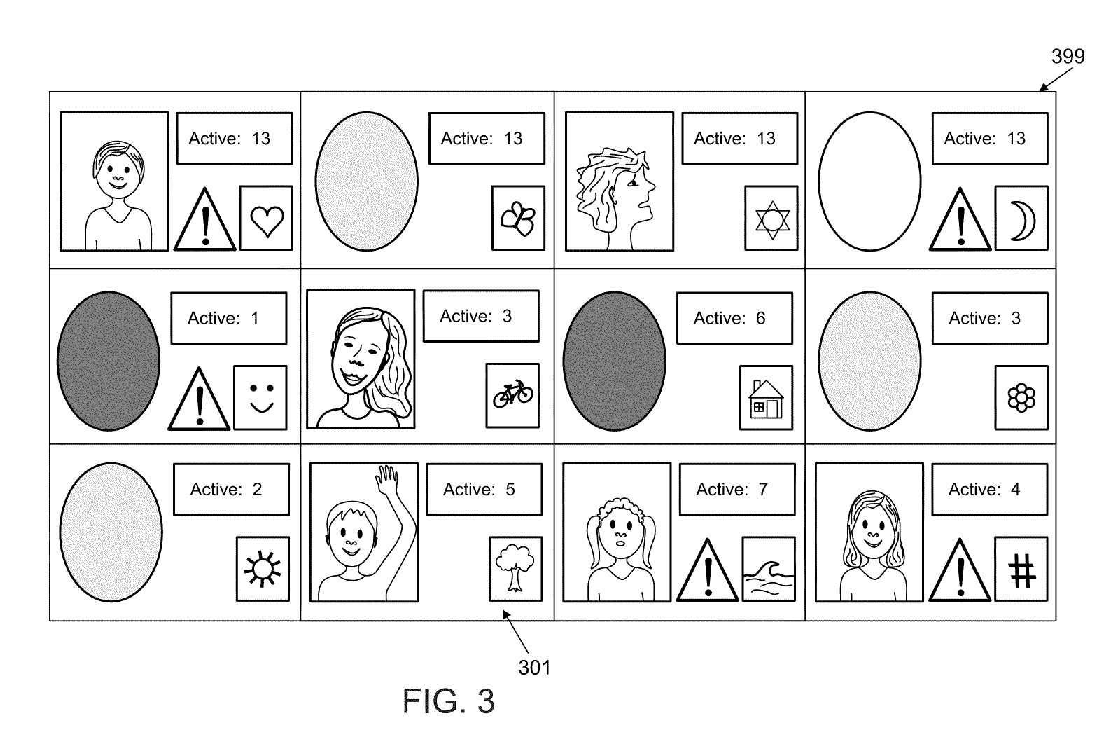

FIG. 3 is an exemplary presentation of a GUI 399, a panel, a grid, of graphical elements that is optionally updated as described above, according to some embodiments of the present invention. The GUI includes a plurality of graphical elements, such 301, each represent current voice discussion features of a discussion in a certain chat room. The panel allows a user to view indicators of a number of voice chat rooms simultaneously. When the user sees a voice chat room that's look interesting, he can join it, for instance when he has something to say or data to upload, and hope that others find the fact that he is talking interesting and join as well.

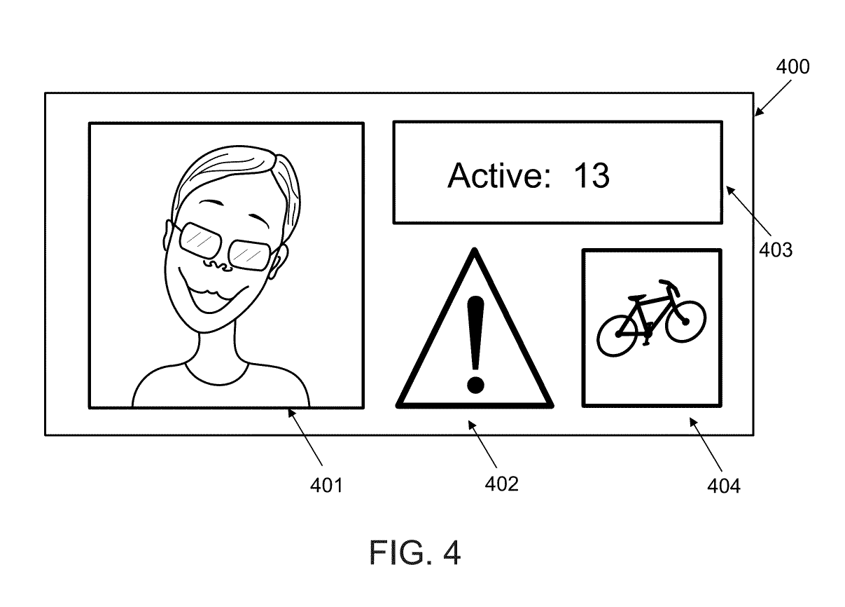

For example, FIG. 4 depicts such an exemplary graphical element 400, according to some embodiments of the present invention. As indicated in this exemplary graphical element 400, one indicator 401 reflects a participant currently speaking; another indicator 402 reflects a detection of a custom voice discussion feature, such as a usage of a word or a term in the current discussion, yet another indicator 403 of the number of active participants, and a group icon 404.

It should be noted that although the above description focuses on voice discussions in voice chat rooms, some embodiments may be implemented to update a user interface that reflects statuses of textual discussions held in instant messaging (IM) groups, asynchronous chat forms and/or the like. In such embodiments, text messages may be analyzed using a text analysis module where voice does not have to be converted to text for extracting some of the above discussion data. In such embodiments, the monitoring module monitors text and not voice and the analysis module identifies current text discussion features in each of a plurality of multi-participant discussions, such as IM groups. The UI is updated to reflect at least some of the current textual discussion features of each of at least some of the multi-participant textual discussions.

The methods as described above are used in the fabrication of integrated circuit chips.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems will be developed and the scope of the term a server, a network, a unit, and/or a module is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of voice discussion features from other embodiments.

The word “optionally” is used herein to mean “is provided in some embodiments and not provided in other embodiments”. Any particular embodiment of the invention may include a plurality of “optional” voice discussion features unless such voice discussion features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain voice discussion features of the invention, which are, for clarity, described in the context of separate embodiments, may also be provided in combination in a single embodiment. Conversely, various voice discussion features of the invention, which are, for brevity, described in the context of a single embodiment, may also be provided separately or in any suitable subcombination or as suitable in any other described embodiment of the invention. Certain voice discussion features described in the context of various embodiments are not to be considered essential voice discussion features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for updating a user interface, comprising:
at least one monitoring module adapted to monitor a plurality of multi-participant voice discussions held in a plurality of voice chat rooms;
a processing unit adapted to:
identify a plurality of current voice discussion features in each of said plurality of multi-participant voice discussions;
update a user interface to reflect at least some of said plurality of current voice discussion features of each of at least some of said plurality of multi-participant voice discussions; and
instruct the presentation of said user interface by a client terminal of a user.

2. The system of claim 1, wherein said presentation simultaneously renders said at least some of said plurality of current voice discussion features of each of said at least some multi-participant voice discussions.

3. The system of claim 1, wherein said user interface is adapted to receive a user selection of one of said plurality of voice chat rooms and to add said user to said selected voice chat room.

4. The system of claim 1, further comprising a preference module to allow said user to define at least some of said plurality of current voice discussion features.

5. The system of claim 1, wherein said at least one monitoring module is adapted to extract, from each one of said plurality of multi-participant voice discussions, at least one audio stream documenting voice of a plurality of participants; wherein said processing unit is adapted to identify at least some of said plurality of current voice discussion features by voice analysis of said at least one audio stream.

6. The system of claim 5, wherein said voice analysis is a sentiment analysis and said plurality of current voice discussion features are selected from a group consisting of: an emotion expressed by one of said plurality of participants, a prevailing emotion expressed by at least some of said plurality of participants, an emotion trend expressed by at least some of said plurality of participants.

7. The system of claim 5, wherein said voice analysis is a speech analysis and said plurality of current voice discussion features are selected from a group consisting of: a word said by one of said plurality of participants, a term said by one of said plurality of participants, a word repeated by at least some of said plurality of participants, a term repeated by at least some of said plurality of participants.

8. The system of claim 5, wherein said voice analysis outputs a stress level as one of said plurality of current voice discussion features in at least some of said plurality of multi-participant voice discussions.

9. The system of claim 5, wherein said voice analysis outputs an activity level reflecting active participation of participants as one of said plurality of current voice discussion features in at least some of said plurality of multi-participant voice discussions.

10. The system of claim 1, wherein said at least one monitoring module is adapted to monitor data acquired from a voice chat unit managing said plurality of voice chat rooms, wherein said processing unit is adapted to identify at least some of said plurality of current voice discussion features by data analysis of said data.

11. The system of claim 1, wherein said at least one monitoring module is adapted to monitor a number of participants which actively participate in each one said plurality of voice chat rooms by at least one of playing respective said discussions and talking, wherein said number is one of said plurality of current voice discussion features.

12. The system of claim 1, wherein said at least one monitoring module is adapted to monitor an identity of participants which actively participate in each one said plurality of voice chat rooms by at least one of playing respective said discussions and talking, wherein said identity is one of said plurality of current voice discussion features.

13. The system of claim 1, wherein said user interface comprises a plurality of graphic elements, each comprises a plurality of indicators each one of said plurality of indicators represents one of said plurality of current voice discussion features.

14. The system of claim 13, wherein said plurality of graphic elements which are arranged in a grid.

15. The system of claim 13, wherein said plurality of indicators comprises a member of a group consisting of an icon of a participant, an icon of a notification, and a counter.

16. The system of claim 1, wherein said processing unit adapted to identify said plurality of current voice discussion features by an analysis of a recent period of said plurality of multi-participant voice discussions; wherein said recent period is shorter than 5 minutes.

17. The system of claim 1, wherein a client module executed at said client terminal is instructed to display the presentation of said user interface by receiving message transmitted over a computer network.

18. A method for updating a user interface, comprising:
monitoring a plurality of multi-participant voice discussions held in a plurality of voice chat rooms;
identifying a plurality of current voice discussion features in each of said plurality of multi-participant voice discussions;
updating a user interface to reflect at least some of said plurality of current voice discussion features of each of at least some of said plurality of multi-participant voice discussions; and
instructing the presentation of said user interface by a client terminal of a user.

19. The method of claim 18, further comprising receiving instructions to monitor said plurality of current voice discussion features from a user via another user interface executed at said client terminal.

20. A computer program product for updating a user interface, the computer program product comprising a non transitory computer readable storage medium having program instructions embodied therewith, the program instructions executable by a processor to cause the processor to:
receive streams of audio documenting a plurality of multi-participant voice discussions held in a plurality of voice chat rooms;
identify a plurality of current voice discussion features in each of said plurality of multi-participant voice discussions;
update a user interface to reflect at least some of said plurality of current voice discussion features of each of at least some of said plurality of multi-participant voice discussions; and
instruct the presentation of said user interface by a client terminal of a user.

21. A method for updating a user interface, comprising:
receiving a plurality of current voice discussion features in each of a plurality of multi-participant voice discussions held in a plurality of voice chat rooms;
updating a user interface to reflect at least some of said plurality of current voice discussion features of each of at least some of said plurality of multi-participant voice discussions; and
instructing the presentation of said user interface by a client terminal of a user.
